(19) United States
(12) Patent Application Publication
(10) Pub. No.: US 2022/0363179 A1
(43) Pub. Date: Nov. 17, 2022

(54) RECONFIGURABLE HANDLEBAR CUP HOLDER

(71) Applicant: Audio Accessories Group, LLC, Tempe, AZ (US)

(72) Inventors: Liang Zhou, NINGBO (CN); Hai Wang, Ningbo (CN); Larry Vansickel, Phoenix, AZ (US)

(21) Appl. No.: 17/318,639

(22) Filed: May 12, 2021

(51) Int. Cl. B60N 3/10

(52) U.S. Cl. CPC B60N 3/103; B60N 3/106

(57) ABSTRACT

A cup holder for attachment to a handlebar or other support having a transverse section of a conical shell for a cup-holding ring. The ring has opposed exterior dual-purpose couplings for engaging arcuate inserts either on the inside of the ring for small cups, or on the outside of the ring for large cups. Arcuate inserts are included, featuring a central coupling section flanked by arcuate arms adapted on the inside curvature to engage the outside of the ring and on the outside curvature adapted to engage the inside surface of the ring. The ring also supports a slide-lock base able to receive an attachment for an external object, such as a handlebar. A handlebar clamp is also provided.

### FIELD OF THE INVENTION

The present invention is in the field of cup holders supported on handlebars. The invention is further in the field of cup holders that are reconfigurable for at least two different sizes of cups.

### BACKGROUND

Cup holders are ubiquitous in modern life and include cup holders for handlebars on bicycles, motorcycles, tricycles, and the like. Presently, many cup holders use resilient materials inside of the cup-receiving ring or cylinder, inevitably favoring one size of cup above all others, resulting in cup ejection when the vehicle to which they are attached transits a bump. Some cup holders accommodate only one size of cup.

U.S. Pat. No. 6,942,131 to Trautman et al. (hereinafter “Trautman”) discloses a cylindrical can with a resilient foam liner for receiving drink containers. Trautman's cylindrical can is readily detachable from Trautman's handlebar mounting. Rudyness Chrome Adjustable Cup Holder for Harley ATV Motorcycle, available from AMAZON, discloses a cylindrical container with a resilient foam liner and an additional spiral sheet of foam for adjusting to smaller beverage containers. Accmor Bike Cup Holder, Stroller Cup Holder, Universal 360 Degrees Rotation Drink Holder for Bicycle, Stroller, Walker, Wheelchair, available from AMAZON, discloses a handlebar cup holder that uses resilient arms to hold beverage containers of various sizes. Accmor Stroller Cup Holder, Bike Cup Holder, Large Caliber Designed Cup Holder for Bottle with Handle, Universal Bottle Holder for Stroller, Bike, Wheelchair, Walker, available from AMAZON, discloses a handlebar cup holder that uses resilient radially inwardly pointing flanges to adjust for various cup sizes.

### SUMMARY

An exemplary cup holder of the present invention includes a cup-receiving ring that is a transverse section of a conical shell adapted to receive a particular large drink cup. A handlebar clamp is releasably attached to the cup-receiving ring. Arcuate inserts are releasably coupled to the outside of the cup-receiving ring when the reconfigurable handlebar cup holder is configured for large cups. To reconfigure the reconfigurable handlebar cup holder for small cups, the inserts are manually released from the outside of the cup-receiving ring and releasably attached to the inside of the cup-receiving ring.

### BRIEF DESCRIPTION OF DRAWINGS

The present invention will hereinafter be described in conjunction with the following drawing figures, wherein like numerals denote like elements, and

FIG. 1 is a perspective exploded view illustrating an exemplary embodiment of a reconfigurable handlebar cup holder, according to a preferred embodiment of the present invention;

FIG. 2 is a perspective view illustrating the exemplary embodiment of a reconfigurable handlebar cup holder of FIG. 1 in a first configuration, according to a preferred embodiment of the present invention;

FIG. 3 is a top plan view illustrating the exemplary embodiment of a reconfigurable handlebar cup holder of FIGS. 1 and 2 in the first configuration, according to a preferred embodiment of the present invention;

FIG. 4 is a front elevation view illustrating the exemplary embodiment of a reconfigurable handlebar cup holder of FIGS. 1-3 in the first configuration, according to a preferred embodiment of the present invention;

FIG. 5 is a side elevation view illustrating the exemplary embodiment of a reconfigurable handlebar cup holder of FIGS. 1-4 in the first configuration, according to a preferred embodiment of the present invention;

FIG. 6 is a perspective exploded view illustrating an exemplary embodiment of the reconfigurable handlebar cup holder of FIGS. 1-5, according to a preferred embodiment of the present invention;

FIG. 7 is a perspective view illustrating the exemplary embodiment of a reconfigurable handlebar cup holder of FIGS. 1-6 in a second configuration, according to a preferred embodiment of the present invention;

FIG. 8 is a top plan view illustrating the exemplary embodiment of a reconfigurable handlebar cup holder of FIGS. 1-7 in the second configuration, according to a preferred embodiment of the present invention;

FIG. 9 is an exploded view illustrating the exemplary embodiment of a reconfigurable handlebar cup holder of FIGS. 1-8 in the second configuration, according to a preferred embodiment of the present invention;

FIG. 10 is a side elevation view illustrating the exemplary embodiment of a reconfigurable handlebar cup holder of FIGS. 1-9 in the first configuration, according to a preferred embodiment of the present invention;

FIG. 11 is a front elevation view illustrating the exemplary embodiment of a reconfigurable handlebar cup holder of FIGS. 1-10 in the first configuration, according to a preferred embodiment of the present invention;

FIG. 12 is a perspective view illustrating the exemplary embodiment of a reconfigurable handlebar cup holder of FIGS. 1-11 in the first configuration, according to a preferred embodiment of the present invention;

FIG. 13 is a top plan view illustrating the exemplary embodiment of a reconfigurable handlebar cup holder of FIGS. 1-12 in the first configuration, according to a preferred embodiment of the present invention;

FIG. 14 is a side elevation view illustrating the exemplary embodiment of a reconfigurable handlebar cup holder of FIGS. 1-13 in the second configuration, according to a preferred embodiment of the present invention;

FIG. 15 is a front elevation view illustrating the exemplary embodiment of a reconfigurable handlebar cup holder of FIGS. 1-14 in the second configuration, according to a preferred embodiment of the present invention;

FIG. 16 is a perspective view illustrating the exemplary embodiment of a reconfigurable handlebar cup holder of FIGS. 1-15 in the second configuration, according to a preferred embodiment of the present invention; and

FIG. 17 is a top plan view illustrating the exemplary embodiment of a reconfigurable handlebar cup holder of FIGS. 1-16 in the second configuration, according to a preferred embodiment of the present invention.

### DETAILED DESCRIPTION OF THE INVENTION

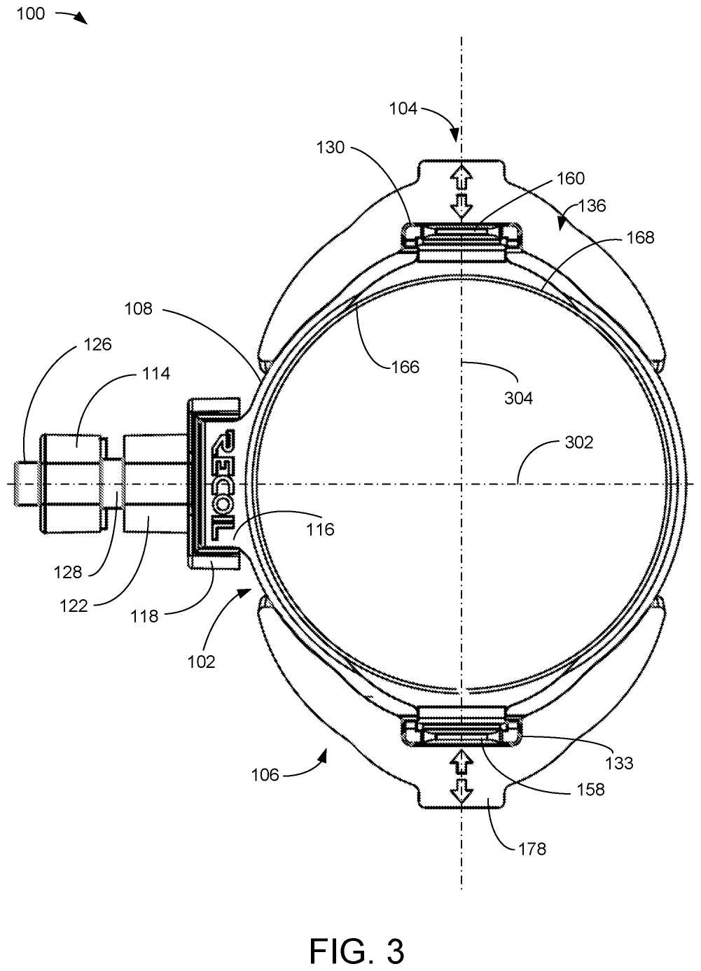

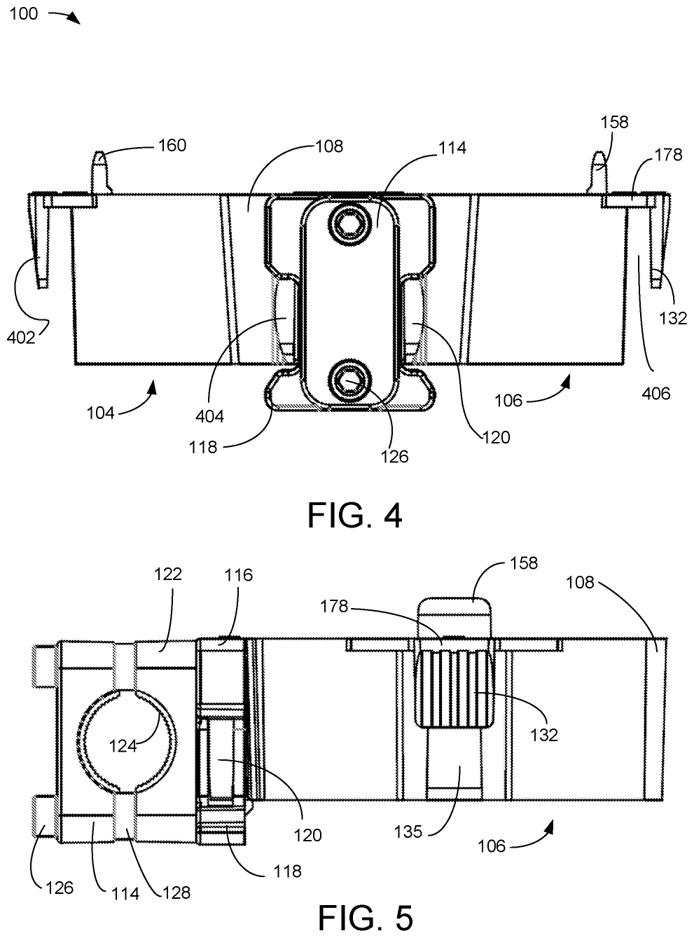

As used and defined herein, terms of position such as “left”, “right”, “front”, “top”, etc. are referenced to the front elevation view shown in FIG. 4. As used and defined herein, terms of relative position such as “inward” and “outward” mean “radially inward” and “radially outward” as referenced to ring 108 in FIG. 3. The hundreds digit(s) used in reference numbers refers to the figure number in which the item is first referenced. Like reference numbers refer to like things.

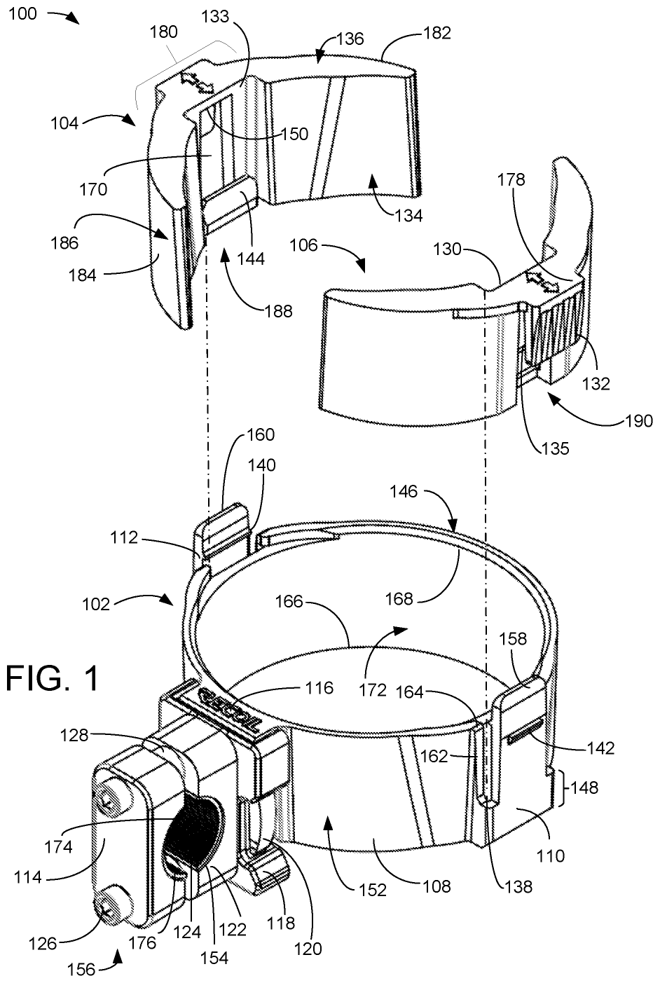

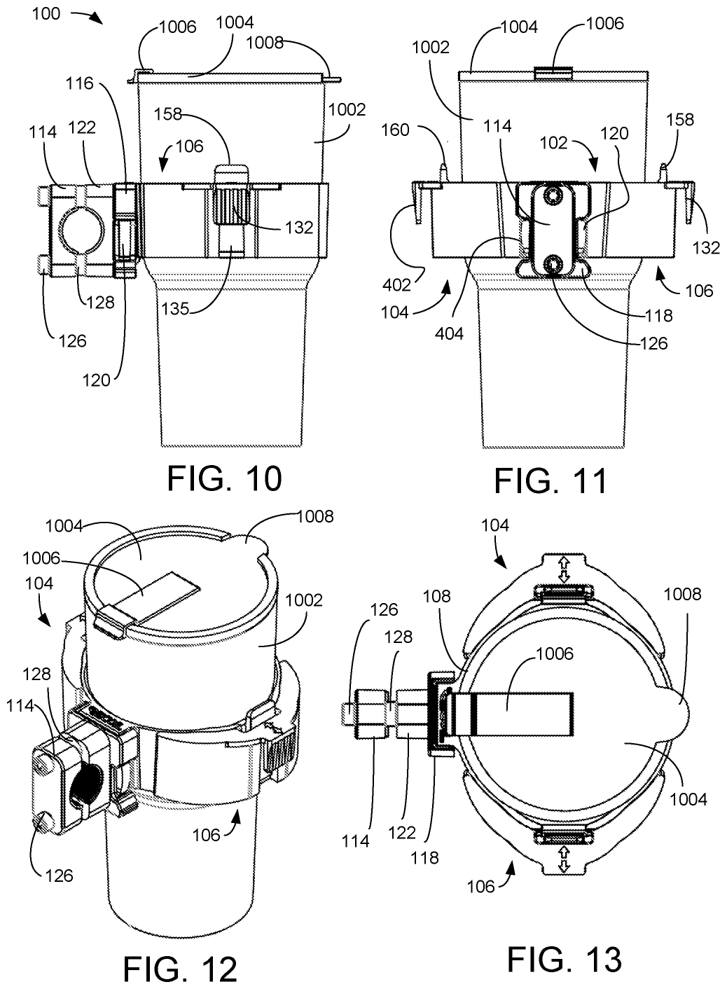

FIG. 1 is a perspective exploded view illustrating an exemplary embodiment of a reconfigurable handlebar cup holder 100, according to a preferred embodiment of the present invention. The reconfigurable handlebar cup holder 100 includes a base 102, a righthand insert 106, and a left-hand insert 104. Base 102 includes ring 108, a righthand dual-purpose resilient coupling 110, a left-hand dual-purpose resilient coupling 112, and a slide-lock base 116. Base 102 is preferably made of injection-molded plastic. In some embodiments, various respective functionally equivalent materials and methods may be substituted for injection-molded plastic. Ring 108 is a doubly transversely truncated conical shell and so has a slight radially inward taper axially towards the bottom, conformable to the taper of a large cup 1002 (see FIGS. 10-13), such as, for non-limiting example, an Artlion 30 oz Stainless Steel Tumbler available from AMAZON®. Ring 108 has a radially inside surface 172 and a radially outside surface 152.

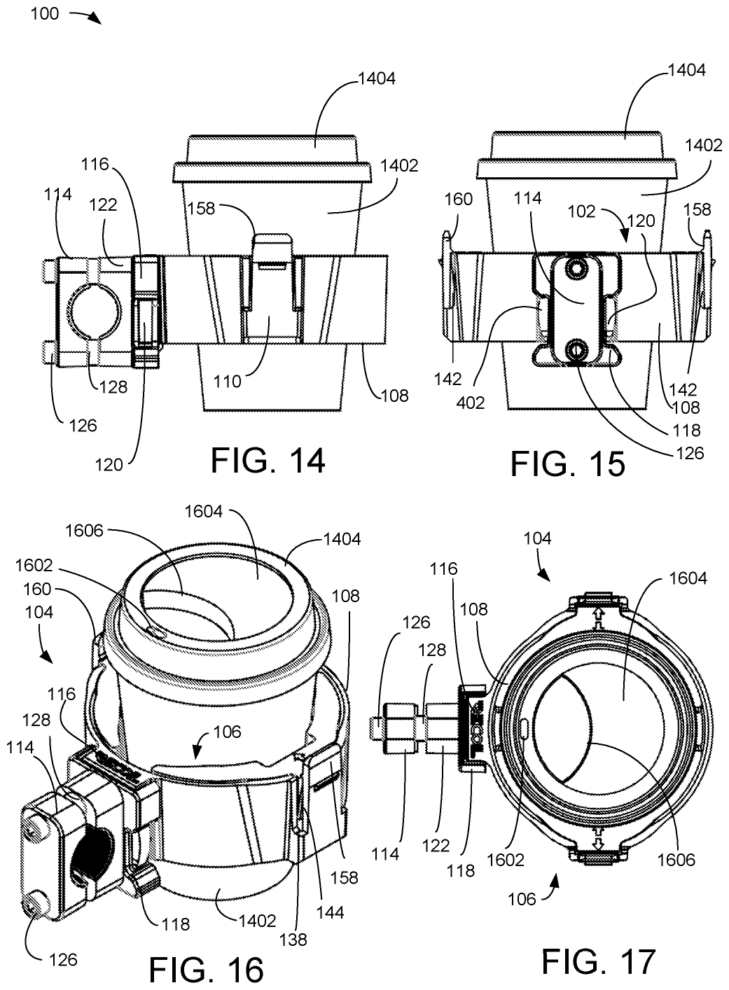

Righthand insert 106 and left-hand insert 104 are identical pieces and so are interchangeable and reduce manufacturing costs. Each insert includes a central coupling section 180, flanked by opposed arcuate tapered arms 182 and 184 having outside surfaces 186 that conform to the inside surface 172 of ring 108 and internal surfaces 134 shaped to assist in holding a small cup 1402 (see FIGS. 14-17). Central coupling section 180 includes a radially inward complimentary coupling portion 188 used for a large cup 1002 configuration (see FIGS. 10-13). The radially inward complimentary coupling portion 188 includes vertical channel 133 extending from the bottom of the left-hand insert 104 to the top of the left-hand insert 104, a cavity 170 within vertical channel 133 extending from the bottom of the vertical channel 133 almost to the top of the left-hand insert 104 thereby creating a lip 150, and a guide 144. Central coupling section 180 also includes a radially outward complimentary coupling portion 190 for the small cup 1402 configuration (see FIGS. 14-17). The radially outward complimentary coupling portion 190 includes an outward extension 178 of a top portion of the central coupling section 180, a panel of alignment ridges 132 extending downward from the outward extension 178, and a ring-receiving gap 406 (see FIG. 4).

Righthand and left-hand dual-purpose resilient couplings 110 and 112 of the ring 108 are shown in quiescent state, but right and left-hand resilient flanges 158 and 160 of right and left-hand dual-purpose resilient couplings 110 and 112, respectively, may be manually flexed radially inwardly or outwardly relative to ring 108. Right and left-hand resilient flanges 158 and 160 are biased toward their quiescent states when flexed. Righthand insert 106 and left-hand insert 104 are shown aligned to be coupled to the outside of ring 108. When righthand insert 106 is installed in the large cup 1002 configuration (see FIGS. 10-13), the radially inward complimentary coupling portion 188 engages a portion of the right-hand dual-purpose resilient coupling 110 purposed for a large cup 1002 configuration. When righthand insert 106 is installed in the large cup 1002 configuration, the top surface 136 (one of two labeled) of each insert 104, 106 will be flush with the top surface 146 of ring 108. In connecting righthand insert 106, channel 130 is slid down over resilient flange 158 until guide 144 (one visible and labeled of two) is within the space between ring 108 and right-hand resilient flange 158, between receiving gap walls 162 (one of two symmetrical arms visible and labeled), and within bottom portion 148. Ring 108 has a bottom inner edge 166 and a top inner edge 168. Receiving gap walls 162 have a top surface 164 extending from ring top surface 146. Guide 144 rests below receiving gap 138 and within bottom portion 148, when installed. A cavity 170 within vertical channel 133 extends from a bottom of righthand insert 106 to a pint just below the top surface 136 of righthand insert 106, thereby creating lip 150. At this point, outside ridge 142 clicks below lip 150 to secure righthand insert 106 on the exterior of the ring 108. Righthand insert 106 may be released by manually bending the top of resilient flange 158 to disengage outside ridge 142 from lip 150, enabling a user to lift righthand insert 106 up and away from ring 108.

When left-hand insert 104 is installed in the large cup 1002 configuration (see FIGS. 10-13), the radially inward complimentary coupling portion 188 engages a portion of the left-hand dual-purpose resilient coupling 112 purposed for a large cup 1002 configuration. The attachment of left-hand insert 104 is similarly done with vertical channel 133 being slid down onto left-hand resilient flange 160. Internal surface 134 of left-hand insert 104 is made of two sections of arcuate surface that engage the radially outside surface 152 of ring 108 when installed in the large cup 1002 configuration (see FIGS. 10-13). The panel of alignment ridges 132 and outer channel 135 are not used in the large cup 1002 configuration (see FIGS. 10-13).

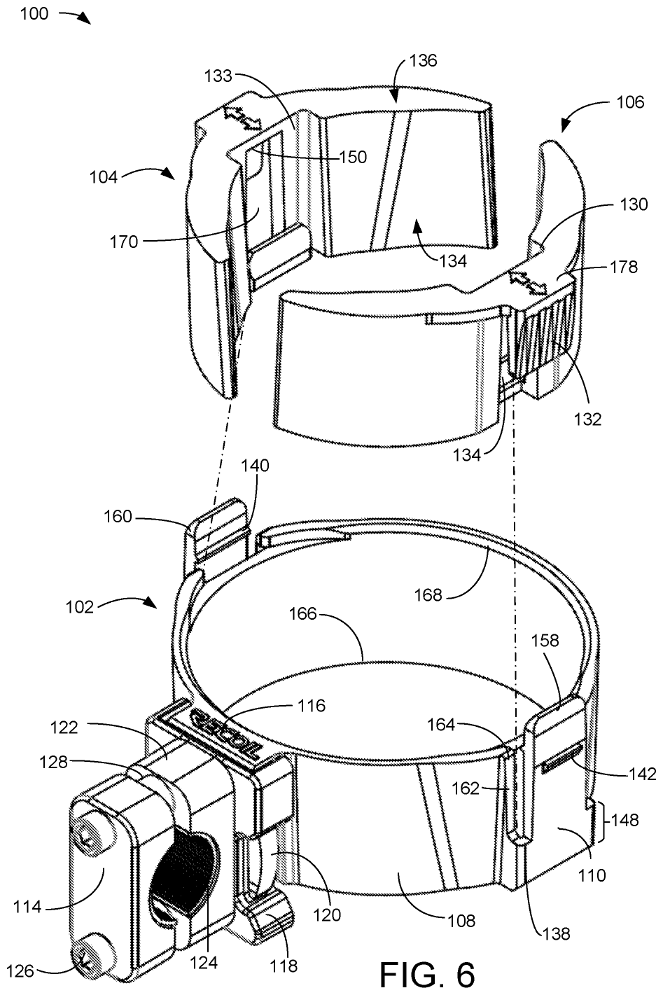

The “dual purpose” of dual-purpose resilient couplings 110 and 112 is to couple the righthand insert 106 and the left-hand insert 104, respectively, to either the inside or the outside of ring 108. Dual-purpose resilient couplings 110 and 112 have, accordingly, some specifically-purposed parts for the inside coupling and some specifically-purposed parts for the outside couplings. Resilient coupling parts purposed for an outside coupling include resilient flange 158, outside ridge 142, receiving gap 138, and receiving gap wall 162. Resilient coupling parts purposed for an inside coupling (see FIGS. 6-8 and 10-13) include resilient flange 158, inside ridge 140, receiving gap 138, and receiving gap wall 162. Arcuate insert parts used for an outside coupling include vertical channel 133, cavity 170, lip 150, and guide 144. Arcuate insert parts used for an inside coupling include an outward extension 178 of a top portion of a central coupling section 180, a panel of alignment ridges 132, and a ring-receiving gap 406 between the panel of alignment ridges 132 and the ring 108.

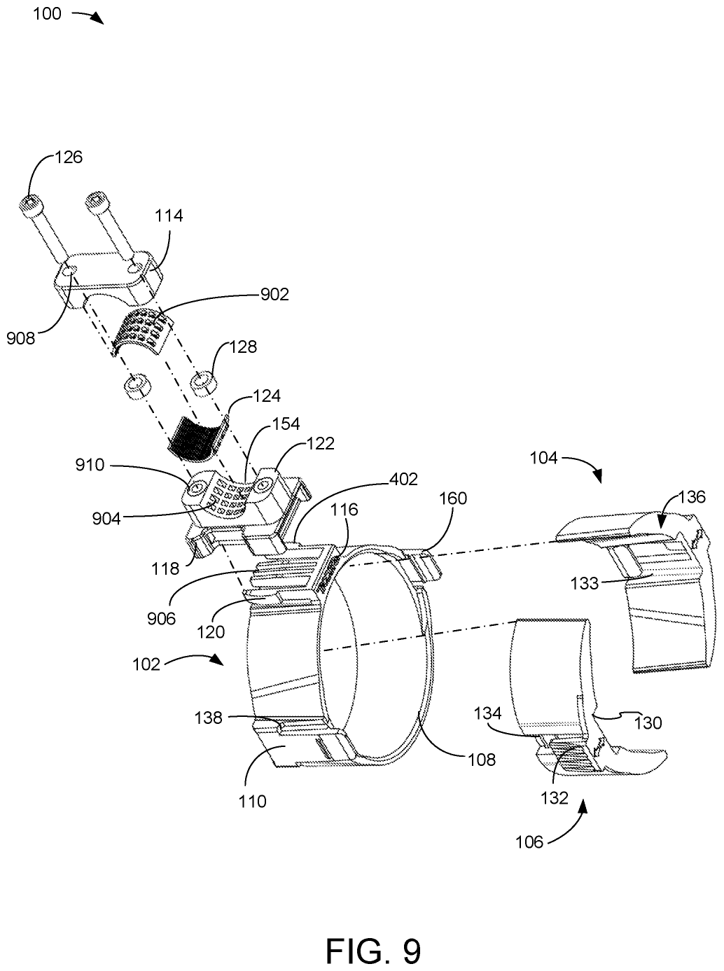

Slide-lock base 116 is preferably of one piece with ring 108 and includes two resilient latches 120 and 404 (see FIG. 4) (one of two is visible in this drawing). Handlebar clamp 156 includes handlebar slide portion 118, first clamp portion 122, second clamp portion 114, spacers 128 (one of two labeled) and bolts 126 (one of two labeled). Slide-lock base 116 receives handlebar slide portion 118 which has two openings through which resilient latches 120 extend and latch during installation. Handlebar slide portion 118 is preferably of one piece with first clamp portion 122. First clamp portion 122 has a transverse semi-cylindrical concavity 154 supporting a traction-enhancing protective pad 124 which both reduces the likelihood of the handlebar clamp 156 rotating on a handlebar and reduces the likelihood of the handlebar clamp 156 fracturing at the junction of the metal handlebar with the plastic handlebar clamp 156. Second clamp portion 114 also has a transverse semi-cylindrical concavity 174 supporting a traction-enhancing protective pad 176 that is aligned to the first clamp portion 122, as shown. Spacers 128 (one of two labeled) may be of various sizes to accommodate some small size range in the diameter of the handlebar. Bolts 126 (one of two labeled) extend through smooth bores 908 (see FIG. 9) in the second clamp portion 114 through spacers 128, respectively, and into aligned threaded bores 910 (see FIG. 9) in the first clamp portion 122 to provide a clamping force.

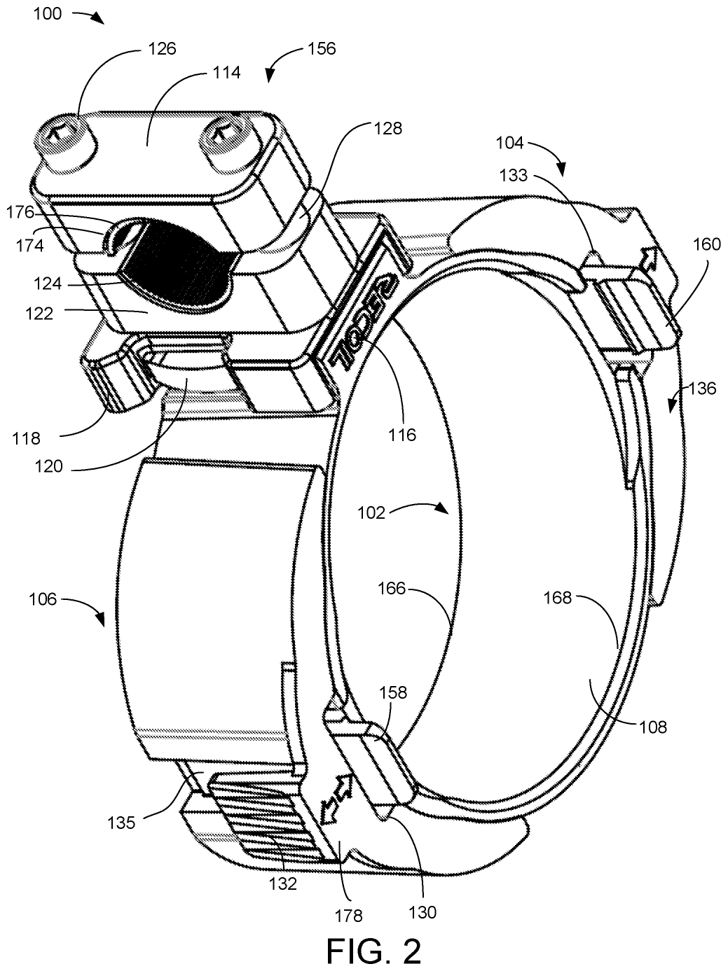

FIG. 2 is a perspective view illustrating the exemplary embodiment of a reconfigurable handlebar cup holder 100 of FIG. 1 in a first configuration, according to a preferred embodiment of the present invention. The illustrated configuration is for large cups 1002 (see FIG. 10) and shows the right hand insert 106 and the left hand insert 104 coupled to the righthand dual-purpose resilient coupling 110 and the left-hand dual-purpose resilient coupling 112, respectively. The panel of alignment ridges 132 and outer channel 135 are not used in this configuration.

FIG. 3 is a top plan view illustrating the exemplary embodiment of a reconfigurable handlebar cup holder 100 of FIGS. 1 and 2 in the first configuration, according to a preferred embodiment of the present invention. The slide-lock base 116 is of one piece with ring 108 and extends radially outwardly from ring 108 symmetric to an first axis 302 that is preferably perpendicular to a second axis 304 between opposed and aligned righthand dual-purpose resilient coupling 110 and the left-hand dual-purpose resilient coupling 112.

FIG. 4 is a front elevation view illustrating the exemplary embodiment of a reconfigurable handlebar cup holder 100 of FIGS. 1-3 in the first configuration, according to a preferred embodiment of the present invention. The second resilient latch 404 can be seen in this view, symmetrical with the labeled resilient latch 120. An outward extension of a top portion of said coupling section Panel of alignment ridges 132 is a mirror image of panel of alignment ridges 402. Ring-receiving gap 406 is used in the small cup configuration (see FIGS. 6-8 and 14-17).

FIG. 5 is a side elevation view illustrating the exemplary embodiment of a reconfigurable handlebar cup holder 100 of FIGS. 1-4 in the first configuration, according to a preferred embodiment of the present invention. While the present embodiment is for a handlebar clamp 156, those of skill in the art, illuminated by the present disclosure, will appreciate the various objects to which ring 108 might be attached using slide-lock base 116 and a complimentary coupling on the object to be attached.

FIG. 6 is a perspective exploded view illustrating an exemplary embodiment of the reconfigurable handlebar cup holder 100 of FIGS. 1-5, according to a preferred embodiment of the present invention. Panel of alignment ridges 132 are shown aligned to receiving gap 138 between dual-purpose resilient coupling 110 and ring 108 and are to be inserted therein for the small cup 1402 (see FIG. 14) configuration. The righthand insert 106 is pressed down until inside ridge 140 snaps over top surface 136, thereby securing the righthand insert 106 inside ring 108. Insertion of left-hand insert 104 is accomplished in the same way with left-hand dual-purpose resilient coupling 112.

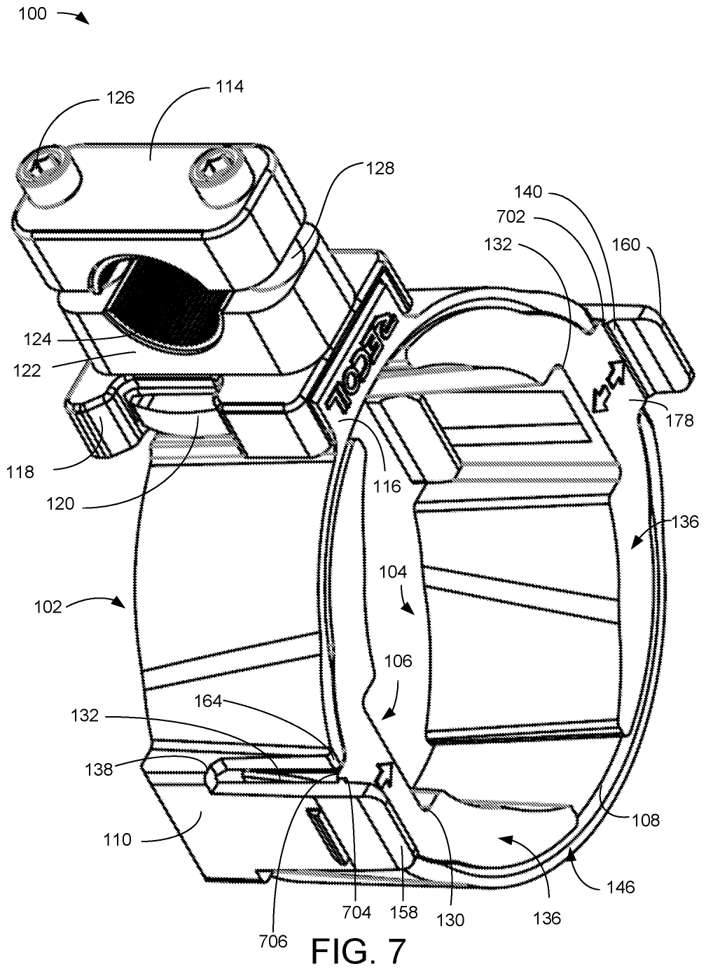

FIG. 7 is a perspective view illustrating the exemplary embodiment of a reconfigurable handlebar cup holder 100 of FIGS. 1-6 in a second configuration, according to a preferred embodiment of the present invention. Inside ridge 140 can be seen snapped over edge 702 of outward extension 178 of top surface 136 of left-hand insert 104. Inside ridge 704 can be seen snapped over edge 706 of outward extension 178 of top surface 136 of righthand insert 106. The panel of alignment ridges 132 can be seen within the receiving gap 138.

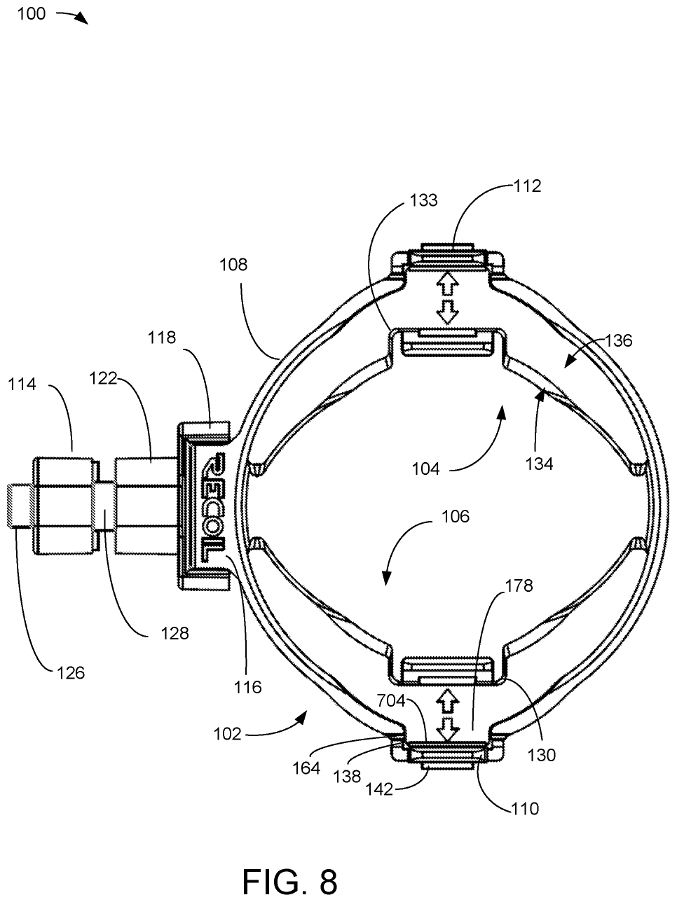

FIG. 8 is a top plan view illustrating the exemplary embodiment of a reconfigurable handlebar cup holder 100 of FIGS. 1-7 in the second configuration, according to a preferred embodiment of the present invention. With the righthand insert 106 and the left-hand insert 104 installed, small cups 1402 (see FIG. 14) can be accommodated. Because the righthand insert 106 and the left-hand insert 104 do not form a circular cavity, small cups 1402 in a small range of various sizes may be accommodated. Internal surfaces 134 (one of four labeled) of righthand insert 106 and left-hand insert 104 are tapered inwardly to their lowest edges. In a particular configuration, left-hand insert 104 may be installed on the inside of ring 108, as shown, while righthand insert 106 is installed on the outside of ring 108, as shown in FIG. 2, thereby accommodating a third size of cup.

FIG. 9 is an exploded view illustrating the exemplary embodiment of a reconfigurable handlebar cup holder 100 of FIGS. 1-8 in the second configuration, according to a preferred embodiment of the present invention. The slide lock-base 116 can be more clearly seen in this view, including both unlatched resilient latches 120 and 402 and alignment rods 906 there between. Handlebar slide portion 118 can be seen to be of one piece with first clamp portion 122. Threaded bores 910 (one of two labeled) receive bolts 126 (one of two labeled). Transverse semi-cylindrical concavity 154 supports a traction-enhancing protective pad 124 (one of two labeled) that is secured to the transverse semi-cylindrical concavity 154 via traction enhancements 176 engaging complimentary traction enhancements 904. In some embodiments, the traction enhancements 176 and 904 may be adhesive. Bolts 126 (one of two labeled) extend through smooth bores 908 (one of two labeled) through spacers 128 (one of two labeled) and thread into threaded bores 910.

FIG. 10 is a side elevation view illustrating the exemplary embodiment of a reconfigurable handlebar cup holder 100 of FIGS. 1-9 in the first configuration, according to a preferred embodiment of the present invention. Large cup 1002 has a lid 1004 which has a tab 1008 for assisting in removing the lid 1004, and a rotatable lid rim-opening cover 1006. In some embodiments, the large cup 1002 is sold with the reconfigurable handlebar cup holder 100. The top portion of large cup 1002 is slightly tapered downward complimentary to the taper of the ring 108.

FIG. 11 is a front elevation view illustrating the exemplary embodiment of a reconfigurable handlebar cup holder 100 of FIGS. 1-10 in the first configuration, according to a preferred embodiment of the present invention. Resilient latches 120 and 404 can both be seen in the latched position in this view.

FIG. 12 is a perspective view illustrating the exemplary embodiment of a reconfigurable handlebar cup holder 100 of FIGS. 1-11 in the first configuration, according to a preferred embodiment of the present invention. Rotatable lid rim opening cover 1006 can be rotated to close, as shown, an opening in the rim of the lid through which the beverage may be imbibed. In some embodiments, rotatable lid rim opening cover 1006 can be rotated to close an opening for receiving a drinking straw.

FIG. 13 is a top plan view illustrating the exemplary embodiment of a reconfigurable handlebar cup holder 100 of FIGS. 1-12 in the first configuration, according to a preferred embodiment of the present invention. The rotational orientation of the large cup 1002, as shown, is not a limitation of the present invention. Any rotational orientation of the large cup 1002 is within the scope of the present invention.

FIG. 14 is a side elevation view illustrating the exemplary embodiment of a reconfigurable handlebar cup holder 100 of FIGS. 1-13 in the second configuration, according to a preferred embodiment of the present invention. Small cup 1402 fits securely in the second configuration of the reconfigurable handlebar cup holder 100. Small cup 1402 may include a raised lid 1404. In some embodiments, the reconfigurable handlebar cup holder 100 is sold without small cup 1402.

FIG. 15 is a front elevation view illustrating the exemplary embodiment of a reconfigurable handlebar cup holder 100 of FIGS. 1-14 in the second configuration, according to a preferred embodiment of the present invention.

FIG. 16 is a perspective view illustrating the exemplary embodiment of a reconfigurable handlebar cup holder 100 of FIGS. 1-15 in the second configuration, according to a preferred embodiment of the present invention. Left-hand insert 104 and righthand insert 106 may, in some embodiments, have a resilient internal surface 134. Lid 1404 includes a cover 1604 having an input opening 1606 and a sipping opening 1602.

FIG. 17 is a top plan view illustrating the exemplary embodiment of a reconfigurable handlebar cup holder 100 of FIGS. 1-16 in the second configuration, according to a preferred embodiment of the present invention. The rotational orientation of the small cup 1402, as shown, is not a limitation of the present invention. Any rotational orientation of the small cup 1402 is within the scope of the present invention.

The claims below contain some functional claiming. There are no statements of intended use in the claims.

We claim:

1. A reconfigurable handlebar cup holder comprising a base further comprising:
a. a doubly transversely truncated conical shell forming an axially tapered ring having a radially inside surface and a radially outside surface;
b. first and second spaced apart, aligned, and opposed dual-purpose resilient coupling parts extending radially outward from said radially outside surface; and
c. a first portion of a slide-lock base extending outwardly from said ring for receiving and releasably securing an attachment to an external object.

2. The cup holder of claim 1, comprising first and second similar arcuate inserts, each insert further comprising:
a. first and second opposed arcuate tapered arms extending from a central coupling section thereby creating an inner curvature and an outer curvature;
b. a first complimentary coupling part, in said central coupling section within said inner curvature, operable to couple a first-purpose portion of one of said first and second opposed dual-purpose coupling parts extending from said outside surface; and
c. a second complimentary coupling part, in said coupling section within said outer curvature, operable to couple a second-purpose section of one of said first and second opposed dual-purpose coupling parts extending from said outside surface.

3. The cup holder of claim 2, wherein said first and second opposed dual-purpose coupling first-purpose portions each comprises:
a. a vertical resilient flange spaced apart from said radially outside surface and extending axially above a height of said tapered ring;
b. a receiving gap between said vertical resilient flange and said outer surface of said ring;
c. a receiving gap wall, of one piece with said tapered ring, extending said height of said ring and extending outward in a bottom portion to be of one piece with said vertical resilient flange; and
d. an outside transverse ridge extending from said resilient flange.

4. The cup holder of claim 3, wherein said first complimentary coupling part comprises:
a. a vertical channel extending from a bottom edge of said insert to a top edge of said insert;
b. a cavity within said vertical channel extending vertically to a lip proximate to, and spaced apart from, a top surface of said arcuate insert; and
c. a guide, within said channel and distal from said lip, configured to slide into said receiving gap.

5. The cup holder of claim 4, wherein said first and second opposed dual-purpose coupling second-purpose portions each comprises:
a. said vertical resilient flange;
b. said receiving gap;
c. said receiving gap wall; and
d. an inside transverse ridge extending from said resilient flange.

6. The cup holder of claim 5, wherein said second complimentary coupling part comprises:
a. an outward extension of a top portion of said coupling section; and
b. a panel of alignment ridges, extending downward from said outward extension of said top portion, wherein said alignment ridges comprise downwardly tapered alignment ridges.

7. The cup holder of claim 1, comprising said attachment.

8. The cup holder of claim 7, wherein said attachment comprises a handlebar clamp.

9. The cup holder of claim 8, wherein said handlebar clamp comprises:
a. a slide portion operable to engage and latch to said portion of said slide-lock base;
b. a first clamp portion of one piece with said slide portion;
c. a second clamp portion aligned to and spaced apart from said first clamp portion via first and second spacers;
d. first and second fasteners operable to be inserted into first and second smooth bores, respectively, in said second clamp portion, then through said first and second spacers, respectively, and then threaded into respective first and second threaded bores in said first clamp portion;

10. The cup holder of claim 9, wherein said handlebar clamp comprises:
a. aligned and opposed first and second semi-cylindrical cavities in respective said first and second clamp portions; and
b. first and second traction-enhancing pads secured to respective first and second semi-cylindrical cavities.

11. The cup holder of claim 9, wherein said handlebar clamp comprises a drinking cup installed in said cup holder.

12. A reconfigurable handlebar cup holder comprising:
a. a doubly transversely truncated conical shell forming an axially tapered ring having a radially inside surface and a radially outside surface;
b. first and second opposed dual-purpose coupling parts extending radially outward from said radially outside surface; and
c. a slide-lock base extending outwardly from said ring for receiving and releasably securing an attachment to an external object;
d. first and second arcuate inserts, each insert further comprising:
i. first and second opposed arcuate tapered arms extending from a central coupling section thereby creating an inner curvature and an outer curvature;
ii. a first complimentary coupling part, in said coupling section within said inner curvature, operable to couple a first-purpose portion of one of said first and second opposed dual-purpose coupling parts extending from said outside surface; and
iii. a second complimentary coupling part, in said coupling section within said outer curvature, operable to couple a second-purpose section of one of said first and second opposed dual-purpose snap-coupling parts extending from said outside surface.

13. The cup holder of claim 12, wherein said first and second opposed dual-purpose snap-coupling each comprises:
a. first purpose parts of said dual-purpose snap-coupling, further comprising;
i. a vertical resilient flange spaced apart from said radially outside surface and extending axially above the height of said tapered ring;
ii. a receiving gap between said vertical resilient flange and said outer surface of said ring;
iii. a receiving gap wall, of one piece with said tapered ring, extending the height of said ring and extending outward in a bottom portion to be of one piece with said vertical resilient flange; and
iv. an outside transverse ridge extending from said resilient flange; and
b. second-purpose parts of said dual-purpose coupling, further comprising:
i. said vertical resilient flange;
ii. said receiving gap;
iii. said receiving gap wall; and
iv. an inside transverse ridge extending from said resilient flange.

14. The cup holder of claim 13, wherein:
a. said first complimentary coupling part comprises:
i. a vertical channel extending from a bottom edge of said insert to a top edge of said arcuate insert;
ii. a cavity within said vertical channel extending vertically to a lip proximate to, and spaced apart from, a top surface of said arcuate insert; and
iii. a guide, within said channel and distal from said lip, configured to slide into said receiving gap;
b. said second complimentary coupling part comprises:
i. an outward extension of a top portion of said coupling section; and
ii. a panel of alignment ridges, extending downward from said outward extension of said top portion, wherein said alignment ridges comprise downwardly tapered alignment ridges sized to be received in said receiving gap.

15. The cup holder of claim 14, wherein said handlebar clamp comprises:
a. a slide portion operable to engage and be latched to said portion of said slide-lock base;
b. a first clamp portion of one piece with said slide portion;
c. a second clamp portion aligned to and spaced apart from said first clamp portion via first and second spacers;
d. first and second fasteners operable to be inserted into first and second smooth bores, respectively, in said second clamp portion, then through said first and second spacers, respectively, and then threaded into respective first and second threaded bores in said first clamp portion;

16. The cup holder of claim 15, wherein said handlebar clamp comprises:
a. aligned and opposed first and second semi-cylindrical cavities in respective said first and second clamp portions; and
b. first and second traction-enhancing pads secured to respective first and second semi-cylindrical cavities.

17. The cup holder of claim 16, comprising one of:
a. said first and second similar arcuate inserts coupled to respective said first and second opposed dual-purpose coupling parts via said respective first purpose parts of said dual-purpose coupling;
b. said first and second similar arcuate inserts coupled to respective said first and second opposed dual-purpose coupling parts via said respective second-purpose parts of said dual-purpose coupling; and
c. said first arcuate insert coupled to respective said first dual-purpose coupling parts via said first purpose parts of said dual-purpose coupling and said second arcuate insert coupled to said second opposed dual-purpose coupling parts via said second purpose parts of said dual-purpose coupling.

18. The cup holder of claim 15, comprising a cup held in said cup holder.

19. A reconfigurable handlebar cup holder comprising:
a. a doubly transversely truncated conical shell forming an axially tapered ring having a radially inside surface and a radially outside surface;
b. first and second identical arcuate inserts having inner and outer coupling portions on a central coupling section of each said arcuate insert;
c. first and second opposed coupling parts extending radially outward from said radially outside surface, wherein said coupling parts are operable to couple at least one of said first and second identical inserts to said radially inside surface or to said radially outside surface.

20. The cup holder of claim 19, comprising:
a. a slide-lock base extending outwardly from said ring;
b. a handlebar clamp, further comprising:
i. a second slide portion operable to engage and be latched to said slide-lock base;
ii. a first clamp portion of one piece with said slide portion;
iii. a second clamp portion aligned to and spaced apart from said first clamp portion via first and second spacers;
iv. first and second fasteners operable to be inserted into first and second smooth bores, respectively, in said second clamp portion, then through said first and second spacers, respectively, and then threaded into respective first and second threaded bores in said first clamp portion;
v. aligned and opposed first and second semi-cylindrical cavities in respective said first and second clamp portions; and
vi. first and second traction-enhancing pads secured to respective first and second semi-cylindrical cavities.
